(19) United States
(12) Patent Application Publication
(10) Pub. No.: US 2006/0087176 A1
(43) Pub. Date: Apr. 27, 2006

(54) Back driving automatic brake system & automatic braking system for equipping in all vehicles, airplanes, ships etc..

(76) Inventor: Henri Duong, Rosemead, CA (US)

Correspondence Address: HENRI DUONG, 316 1/2 E. GLENDON WAY, ALHAMBRA, CA, 91801, US

(21) Appl. No.: 10/725,226

(22) Filed: Dec. 1, 2003

(51) Int. Cl. B60T 8/32

(52) U.S. Cl. 303/191

(57) ABSTRACT

This is an anti-collision system with radars or sensors to detect and automatic braking unit for equipping in all vehicles, airplanes, ships etc., it functions to brake by itself automatically averting accident to stop collision in case of emergency. Automatic stop control light is a modern traffic security system installed additionally with extra flash/color lighting lamp to focus its beam on front car radars reacting the function of Automatic braking unit to stop cars advancing on red in the lighting zone limit.

### CROSS-REFERENCE TO RELATED APPLICATIONS

Automatic braking system was formerly filed at US Patent and Trademark Office under reference cited:
application Ser. No. 09/943,930 filing date: Aug. 27, 2001 and Publication no: U.S. 2003-0038542 A1 date Feb. 27, 2003
Disclosure Document Deposit Request no: 528018 date Mar. 17, 2003

### STATEMENT REGARDING FEDERALLY SPONSORED RESEARCH

“Not Applicable”

### REFERENCE TO A MICROFICHE APPENDIX

“Not Applicable”

### BACKGROUND OF THE INVENTION

Description creates range structures of Automatic braking system and Back driving brake system for purpose of fitting different types and structures of vehicle in automobile industry. Back driving automatic brake system is newly developed to the point that back driving can well be averted accident but vehicles do not possess such system.

### BRIEF SUMMARY OF THE INVENTION

Automatic braking system and Back driving automatic brake system are for equipping in all vehicles, automobiles, cars, trucks, buses, vans, trains, motor-vehicles, motorcycles, airplanes, ships as anti-collision system to stop accident.

The system composes of essential parts: Radars, sensors, detectable devices, infrared lenses, cameras, projectors or any other similar devices to detect, motors or equivalents, electric wires, contacts, buttons for driver use, switches, support springs, yellow or red signal lamps, thermostats, message recorders, different types of pedal parts, rubber boots & covers, automatic braking pedals, automatic water switches, automatic stop control lamps, accessories and structure triangle wheel: Triangle wheel, inner triangle wheel, ball bearing, pin, spring, moving ball, frame, arm, lock iron switches, structure triangle wheel Duo: Triangle wheel, lock device, bracket arm, arm, spring, pin, ball bearing, iron bar, bracket, frame, structure triangle wheel Du: Triangle wheel, lock device, bracket arm, frame, outer or inner rewind spring, bar, arm, wheel arm, bracket, switch device, structure round wheel Duo-A: Round wheel, outer or inner rewind spring, bracket arm, arm, iron bar, lock device, structure round wheel Duo-a: Round wheel, frame with bar, springs, ball bearing with pin, frame with moving ball, lock devices, inner round wheel, structure screw & unscrew Duo-B: Toothed spindle, frame with gear-nut, lock device, springs, structure axis-gear Duo-C: Axis in groove end part, gear, frame with short tube outlet, rewind springs, spring, lock device, structure extra outlet Duo-D: Extra outlet, round wheel, connecting rod kit with roller & ball bearings, spring, lock device, structure moving frame Duo-E: Extra outlet, round wheel, connecting rod kit with roller & ball bearings, spring air releasing unit, moving frame, rubber cover wheel in double pulley, bearing, oscillator, spring, lock device, hose, structure bracket drive Duo-F: Hidden frame, iron bar, rectangular bracket, springs, lock device, pin, structure direct spin Duo-G: Iron bar, inner wheel, outer or inner rewind spring, lock device, structure oval wheel Duo-H: Oval wheel, outer or inner rewind spring, bracket arm, iron bar, lock device, structure hexagonal wheel Duo-I: Hexagonal wheel or equivalent, inner hexagonal wheel, outer or inner rewind spring, bracket arm, iron bar, lock device.

### BRIEF DESCRIPTION OF THE DRAWINGS

FIG. 1: Triangle wheel is equipped with motor

FIG. 2: Different views of triangle wheel

FIG. 3: Structure Duo (7A)

FIG. 4: Structure Duo (7B)

FIG. 5: Different views of structure Duo

FIG. 6: Structure Du (7A)

FIG. 7: Structure Du (7B)

FIG. 8: Different views of structure Du

FIG. 9: Structure Du with double spin motor (7B)

FIG. 10: Different views of structure Du d.s.m.

FIG. 11: Round wheel structure Duo-A

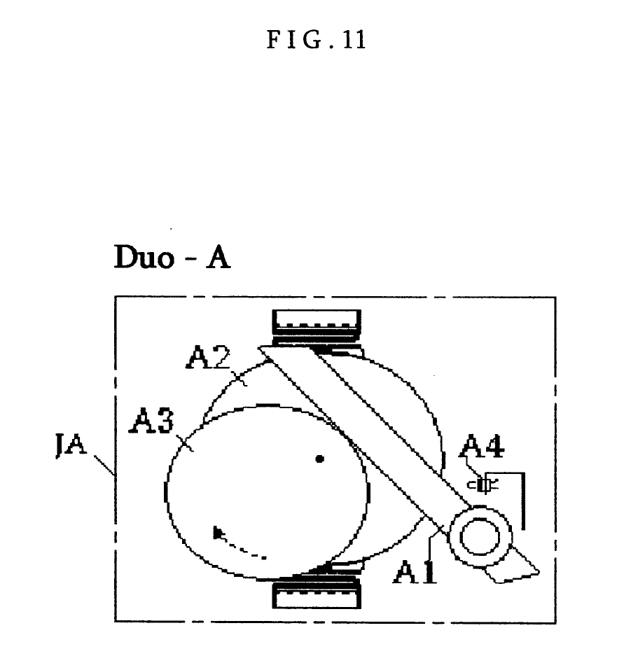

FIG. 12: Different views of structure Duo-A

FIG. 13: Round wheel structure Duo-a

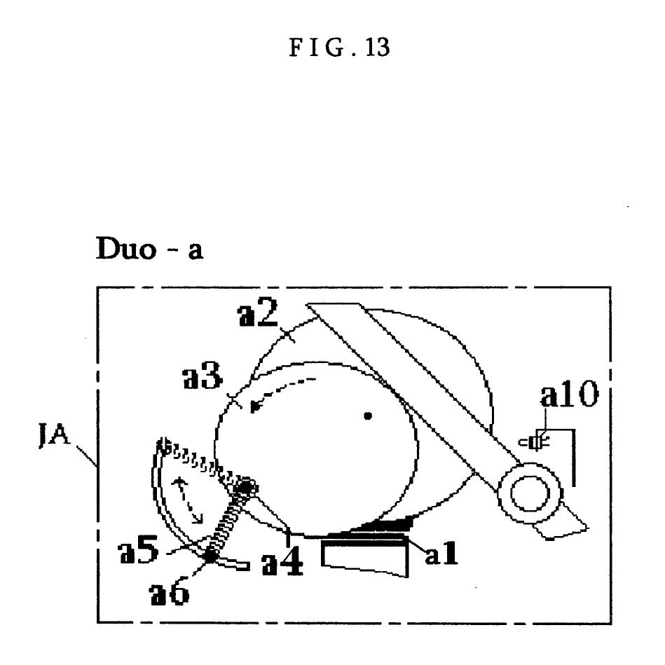

FIG. 14: Different views of structure Duo-a

FIG. 15: Screw & Unscrew structure Duo-B

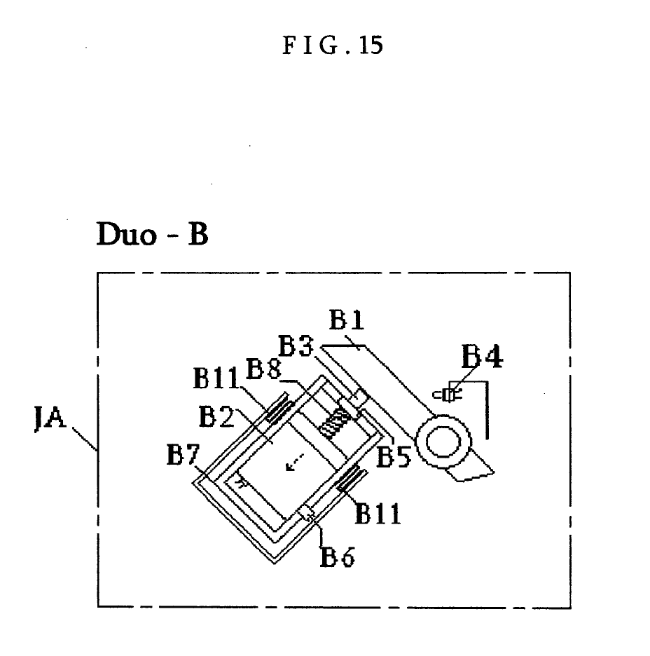

FIG. 16: Different views of structure Duo-B

FIG. 17: Axis-gear structure Duo-C

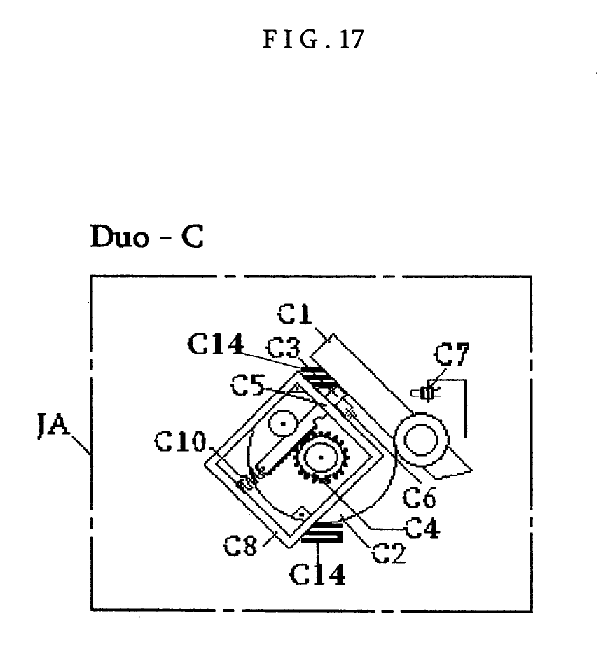

FIG. 18: Different views of structure Duo-C

FIG. 19: Extra outlet structure Duo-D

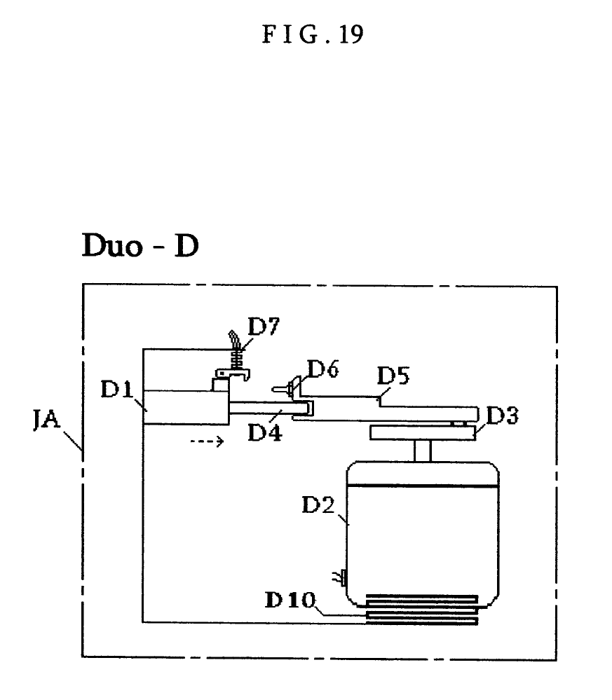

FIG. 20: Different views of structure Duo-D

FIG. 21: Moving frame structure Duo-E

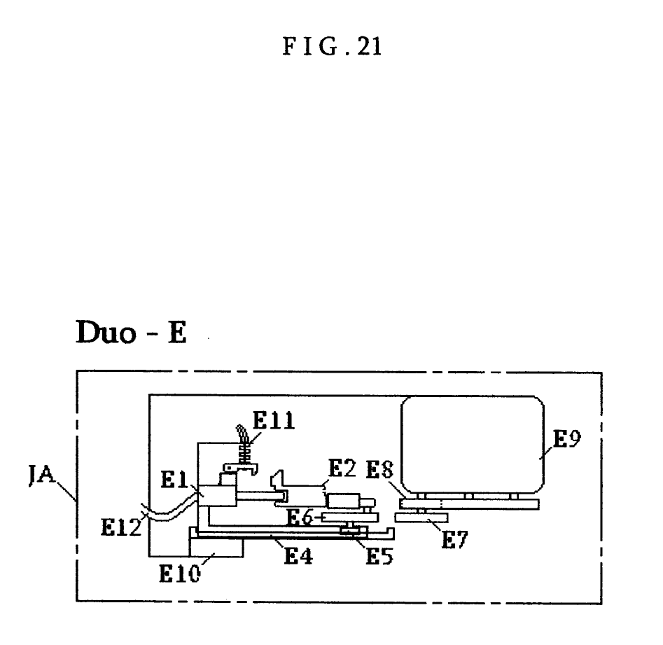

FIG. 22: Different views of structure Duo-E

FIG. 23: Bracket drive structure Duo-F

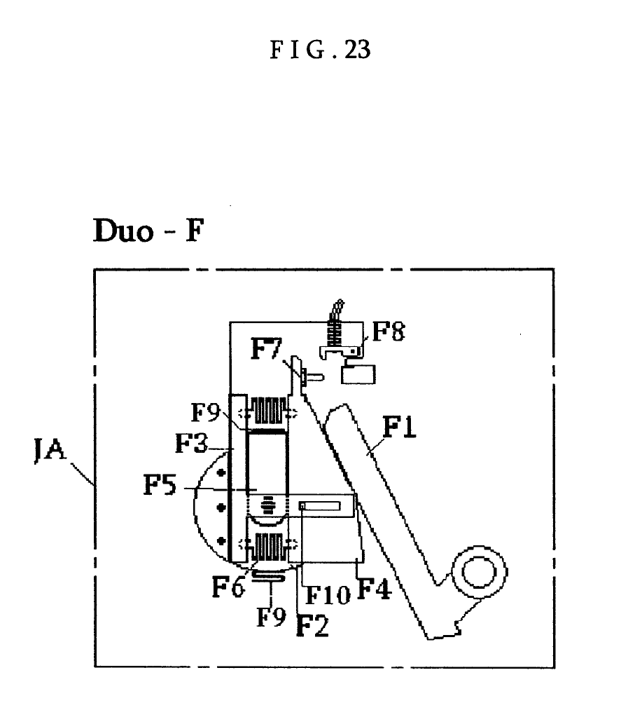

FIG. 24: Different views of structure Duo-F

FIG. 25: Direct spin structure Duo-G

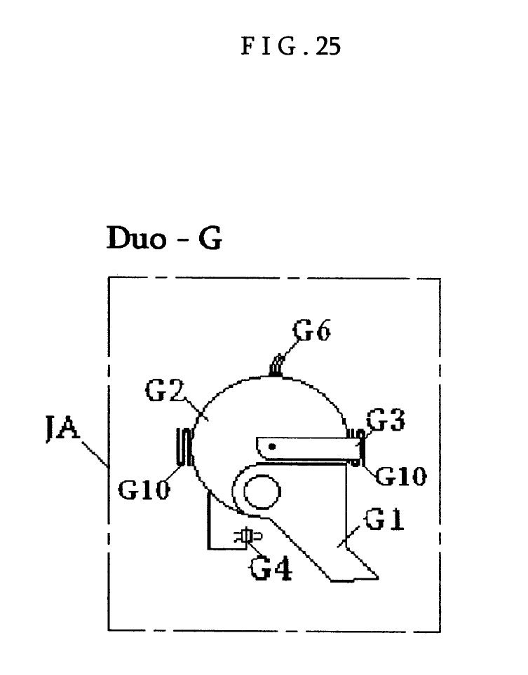

FIG. 26: Different views of structure Duo-G

FIG. 27: Oval wheel structure Duo-H

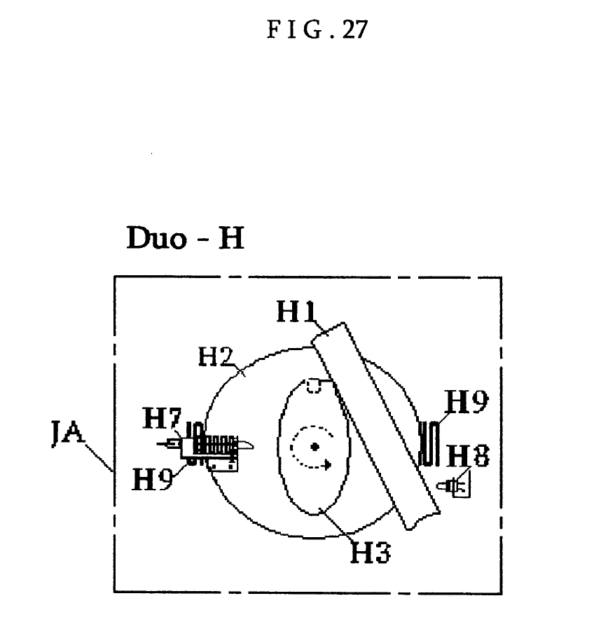

FIG. 28: Different views of structure Duo-H

FIG. 29: Hexagonal wheel structure Duo-I

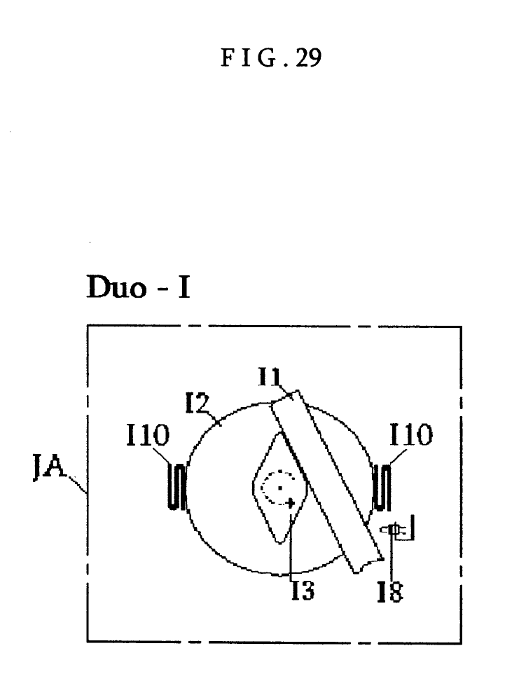

FIG. 30: Different views of structure Duo-I

FIG. 31: Entire braking system network

FIG. 32: Electrical circuit.

FIG. 33: Braking system network

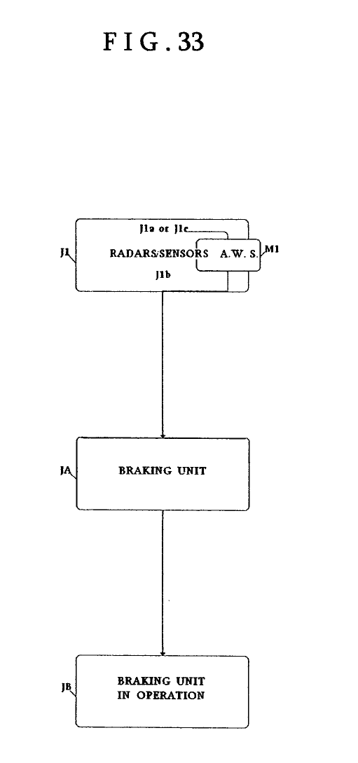

FIG. 34: Red or yellow lamp and its function

FIG. 35: Safe protection cover

FIG. 36: Various types of new pedal

FIG. 37: Other types of new pedal

FIG. 38: Extra outlet rods and braking motors

FIG. 39: Automatic braking pedals

FIG. 40: Further automatic braking pedals

FIG. 41: Detecting distance of radars J1a & J1c

FIG. 42: Automatic water switch

FIG. 43: Automatic stop control lamp

### DETAILED DESCRIPTION OF THE INVENTION

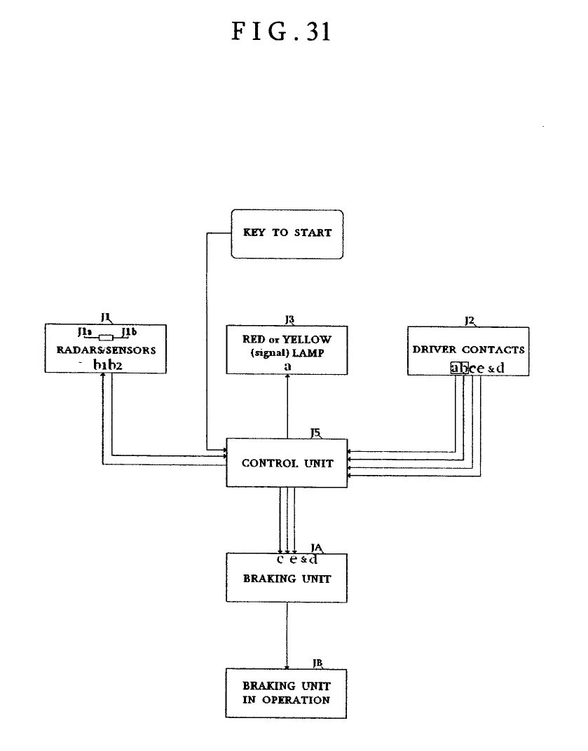

Automatic brake system and Back driving automatic brake system are of anti-collision system to avert accident. FIG. 31 radar(s) or sensor(s) J1b is for equipping at rear car, it reacts to detect only if driver backs its car at near distance having the same function and electrical connection as car backing light while the other radars or sensors J1a and J1c are fixed on the top of front car or hidden part in its front at a position to avert direct lighting flashing on it from opposite running cars to maintain its proper functioning particularly at night time. Once obstruction is detected, radar(s) J1 reacts automatically to switch braking motor on to brake the car immediately JB to stop accident.

We may use the following devices having the same detectable results: Radar, sensor, detectable device, infrared lenses, camera, projector or any other similar devices. The invention includes by nature the original fundamentals as well as elements of Back driving automatic brake system and Automatic braking system or any other structures, modifications, replacement of parts assembling to make up the same system or to perform similar system referring to their original fundamentals to the same effect, combining the invention with any other devices or systems by changing its name or not, contents, structures, illustrations, process of making the invention in these documents.

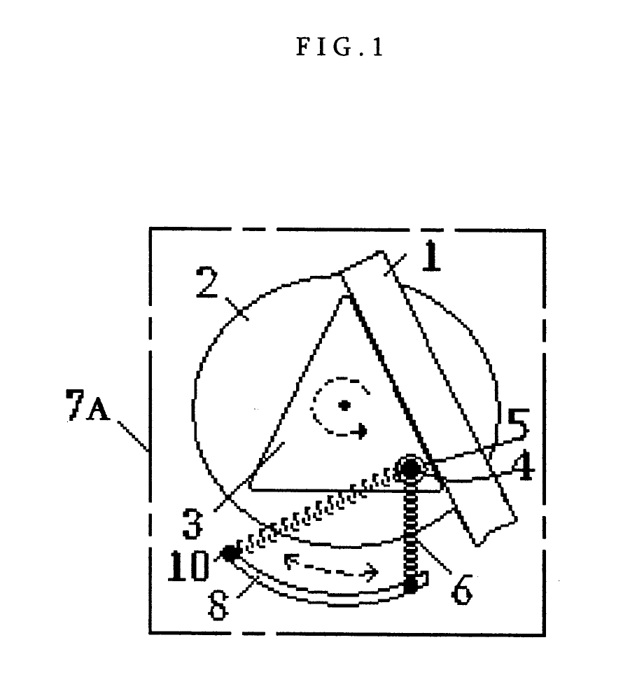

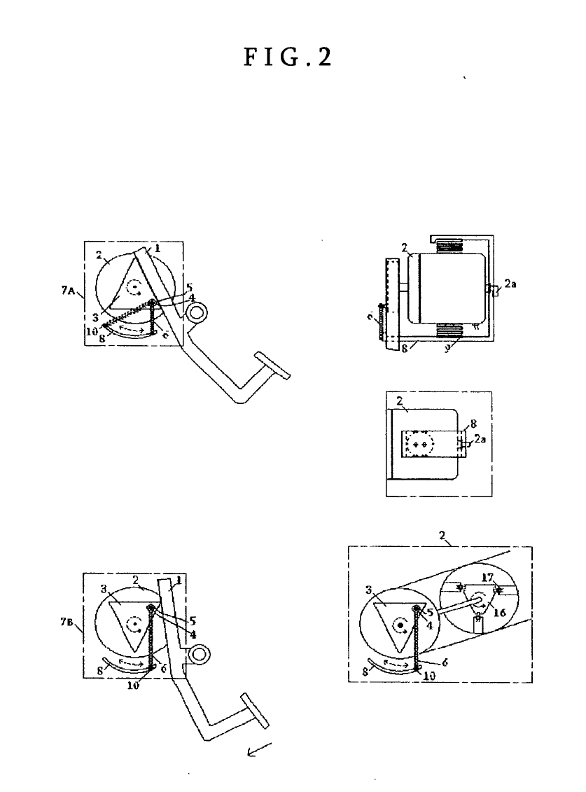

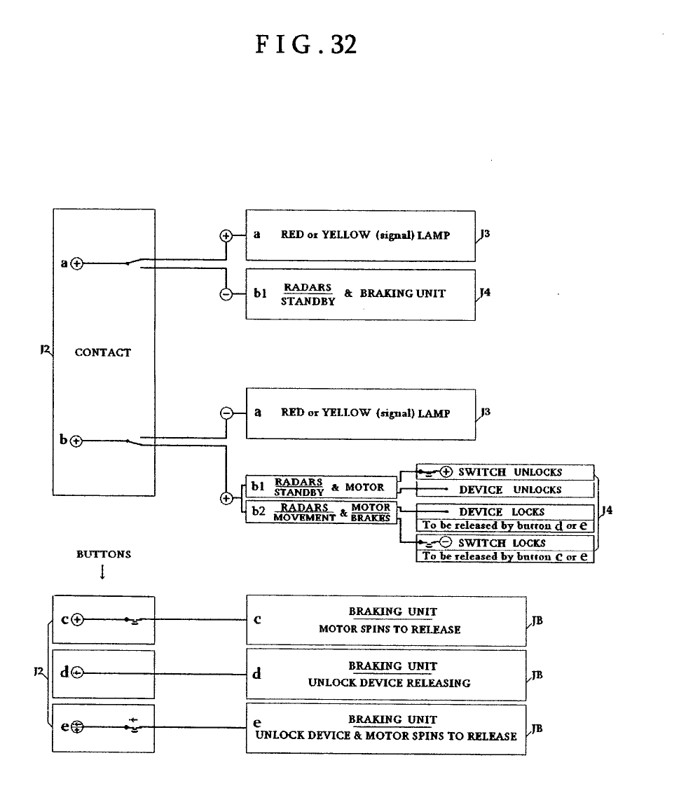

FIG. 1; Structure triangle wheel: 7A Radar(s) reacts to brake, there is a ball bearing 5 with pin 4 fixed firmly at the surface of wheel 3 nearby its flat part corner where a spring 6 is fastened from pin 4 to a moving ball 10 of motor frame 8 pulling wheel at the right position after each spin so as to unlock the brake pedal 1 at 7B on FIG. 2. FIG. 2; We set three iron switches 17 or similar locking device inside motor at positions to turn motor off prior to locking at edge points of an inner triangle wheel 16 at braking position. We fix motor 2 between two strong springs 9 to support its spin, motor is linked with arm 2a at its end to frame 8 letting motor moving at its specific position. FIG. 32; Button J2c or J2e is utilized to switch motor on rotating at the same spin or opposite spin to release the brake.

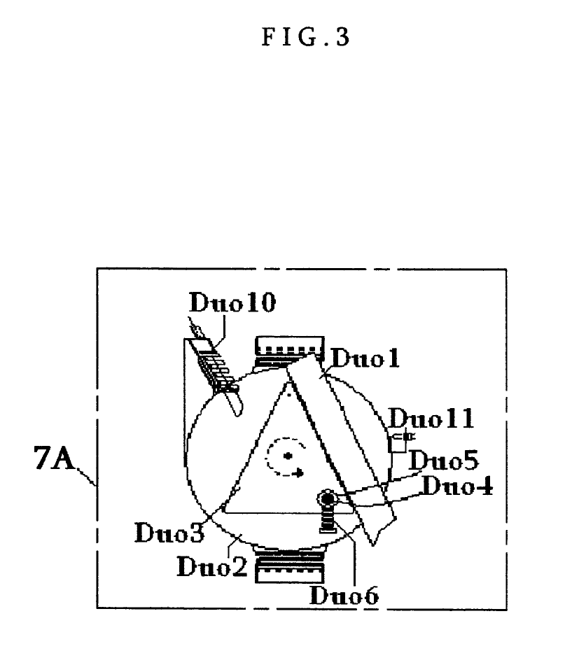

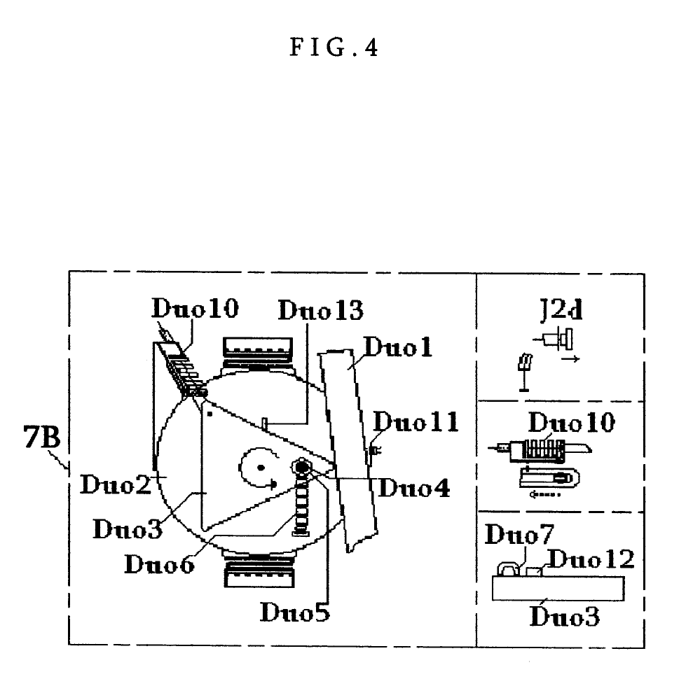

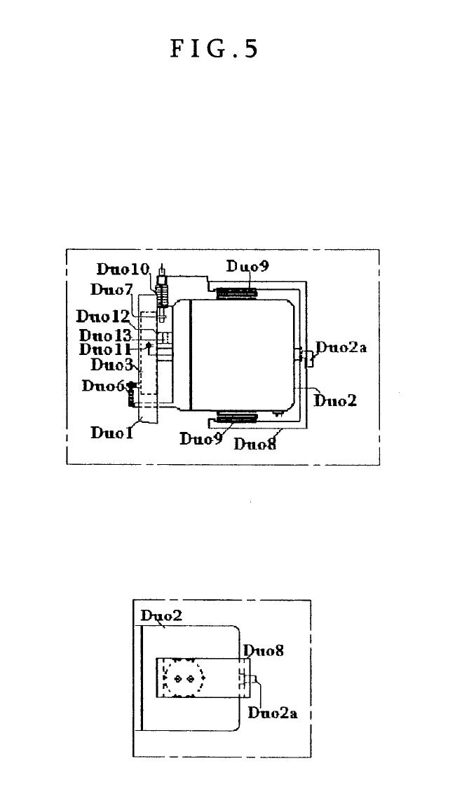

FIG. 3; Triangle wheel structure Duo: 7A once radar(s) or sensor(s) functions, FIG. 4 at 7B triangle wheel Duo3 turns to brake on pedal part Duo1, it will be locked by motor lock device Duo10 to its bracket arm Duo7 at braking position after motor Duo2 is turned off by switch Duo11, motor is linked with a spring Duo6 to pull triangle wheel by its pin Duo4 rotating a ball bearing Duo5 for back spin. Releasing is drawn by driver's button J2d rotating wheel to iron bar Duo13 blockaded at wheel bracket Duo12 (FIG. 5). FIG. 5; We fix motor between two supporting springs Duo9 ending with an arm Duo2a to the frame Duo8.

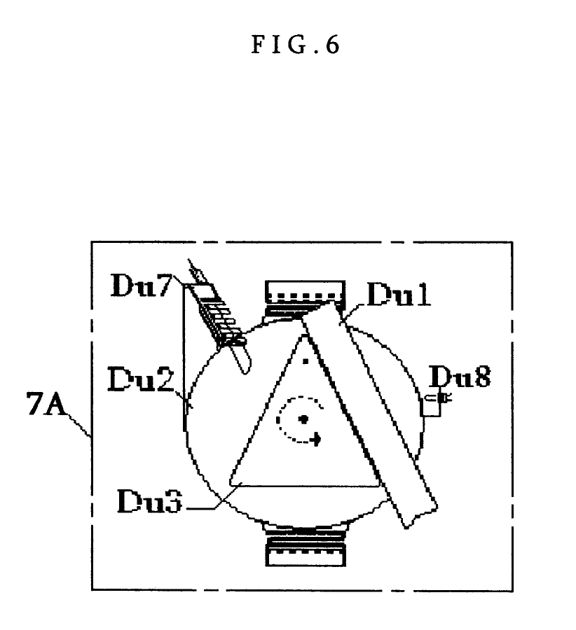

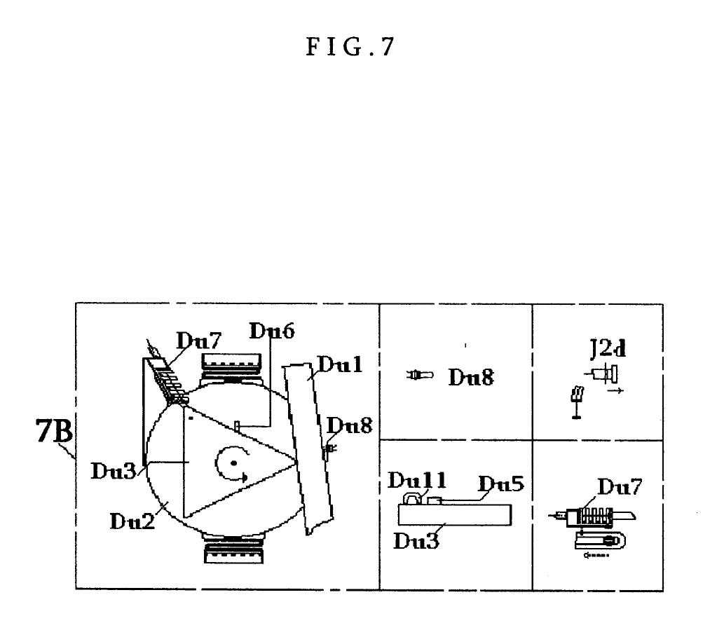

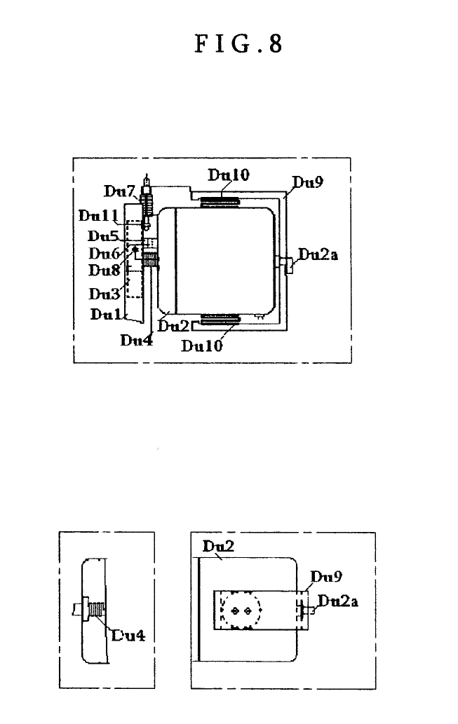

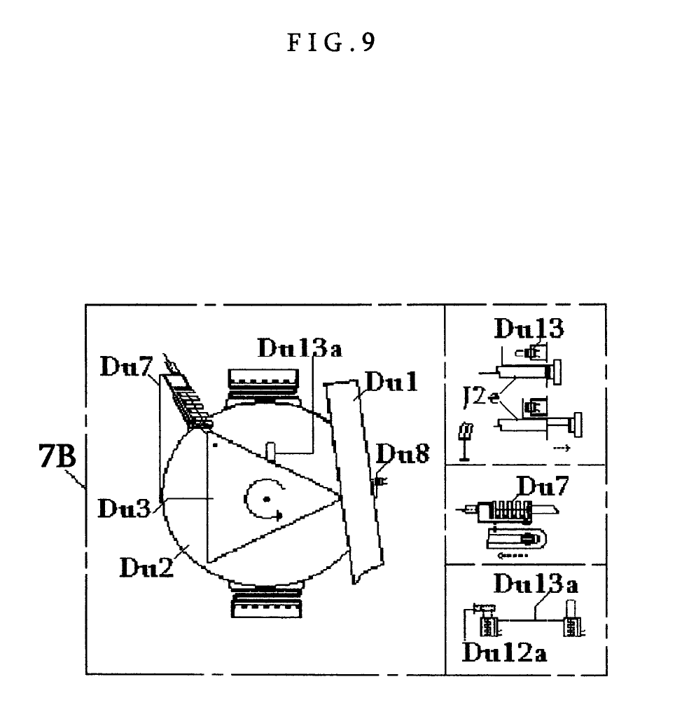

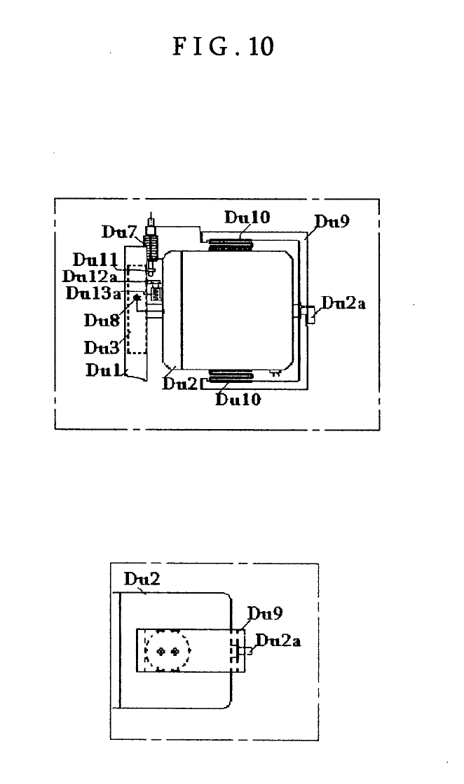

FIG. 6; Triangle wheel structure Du: 7A motor Du2 has its triangle wheel Du3 to brake on pedal part Du1, FIG. 7; braking 7B is locked by lock device Du7 to wheel bracket arm Du11 after turning off by switch Du8, driver's button J2d is drawn for releasing. FIG. 8; Motor ending with arm Du2a is fixed by two springs Du10 in a frame Du9, back spin is by outer or inner rewind spring Du4 rotating to blockade wheel arm Du5 to motor bar Du6. FIG. 9; 7B if a double spinning motor is used replacing rewind spring, we draw driver's button J2e-Du13 on releasing and FIG. 10; wheel bracket Du12a will be locked at switch device Du13a turning motor at back spin off. Radar(s) functions as usual.

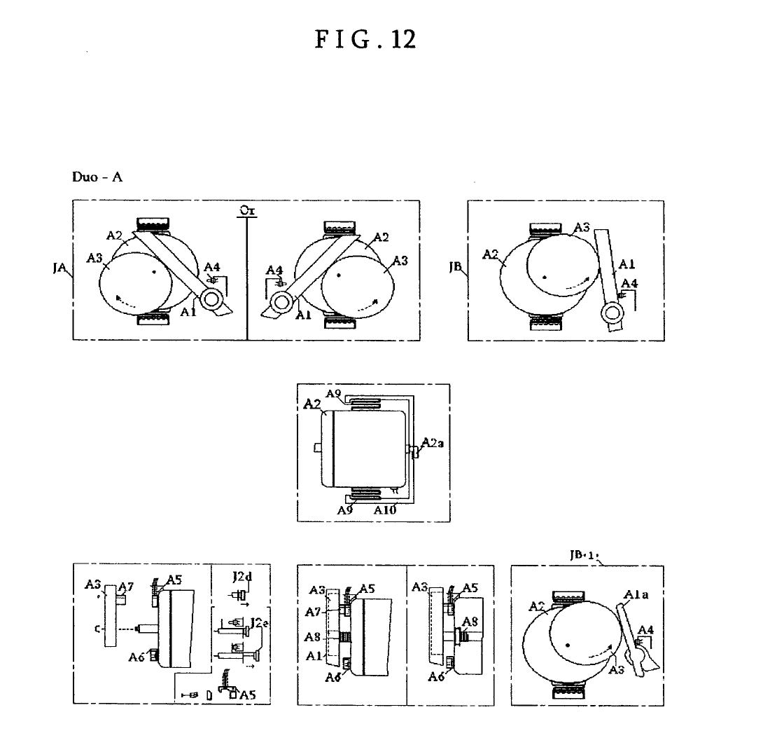

FIG. 12; Round wheel structure Duo-A: JA We equip a round wheel A3 to brake, motor axis is particularly fixed at the border between center and rim of the wheel. Radar(s) or sensor(s) reacts, motor A2 which rotates to brake JB or JB(1) holds a lock device A5 out to lock its wheel A3 by blockading its bracket arm A7 after motor is turned off by switch A4 at its braking summit spin. Outer or inner rewind spring A8 is for back spin, motor is fixed between two supporting springs A9 in the frame A10. It ends with an arm A2a moving at specific position, releasing is drawn by driver's button J2d. If we use a motor turning at both sides: It turns one side to brake and turns the other side to release pedal part A1 or A1a by driver's button J2e rotating wheel to switch A6 off.

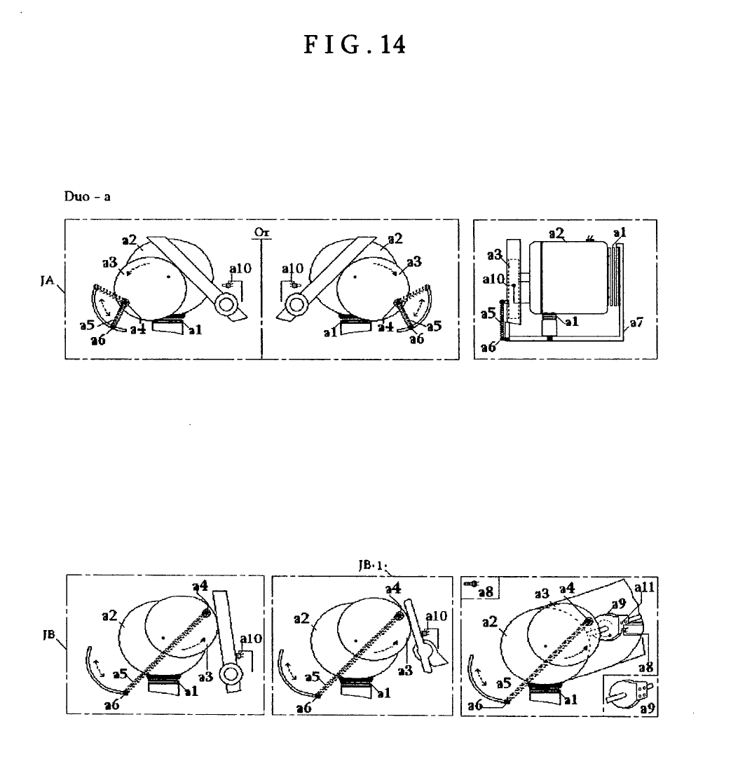

FIG. 14; Round wheel structure Duo-a: JA Braking motor a2 places at a frame with springs a1 to support its movement at single spin. There is a ball bearing with pin a4 fixed firmly at the surface edge of round wheel a3 where a spring a5 is fastened from pin to a moving ball a6 of motor frame a7 pulling the wheel at right position to unlock the brake. Switch a10 is set at position to turn motor off prior to locking inner wheel a9 by two lock devices a8 at braking position JB or JB(1), inner wheel has four locking holes a11, lock devices will lock at either first line or second line of two holes based on motor rotating at off speed. We switch driver's contact J2c (FIG. 32) on rotating to release the brake and function is by radars or sensors.

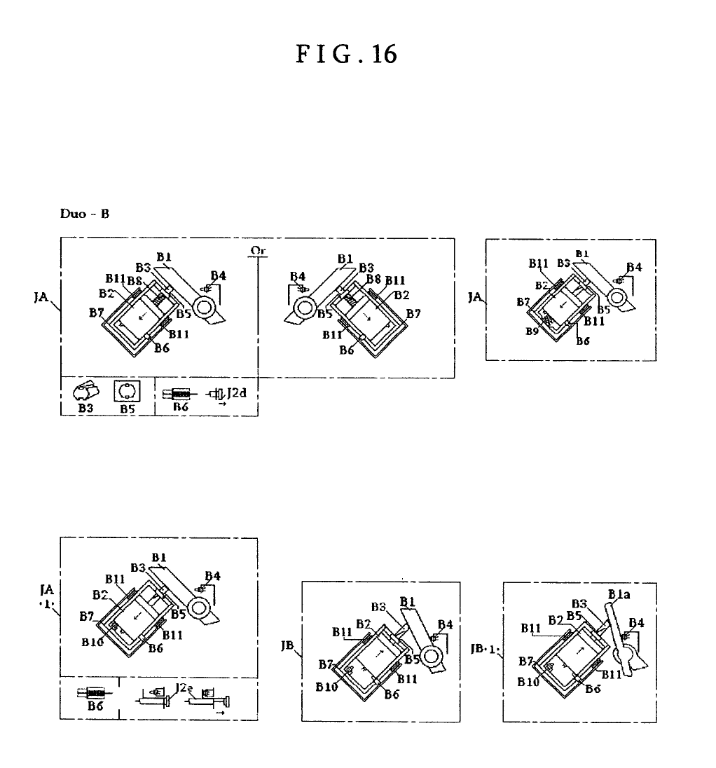

FIG. 16; Screw & Unscrew structure Duo-B: JA motor B2 is installed in spring B11 supporting frame B7 with nut B5 as its outlet, since toothed spindle B3 of motor engages with and through this gear-nut B5, radar(s) or sensor(s) functions, motor moves in its frame and spindle screws out braking against pedal part B1 at JB or automatic brake pedal Bla at JB(1), switch B4 turns off motor which will be locked by lock device B6. Spindle slots into spring B8 before inserting to gear-nut or a spring B9 is fixed at the end of motor for its return spin releasing by driver's button J2d. If double rotating motor is used, driver's contact J2e is to release at return spin, a switch B10 is added letting back spinning motor off JA(1).

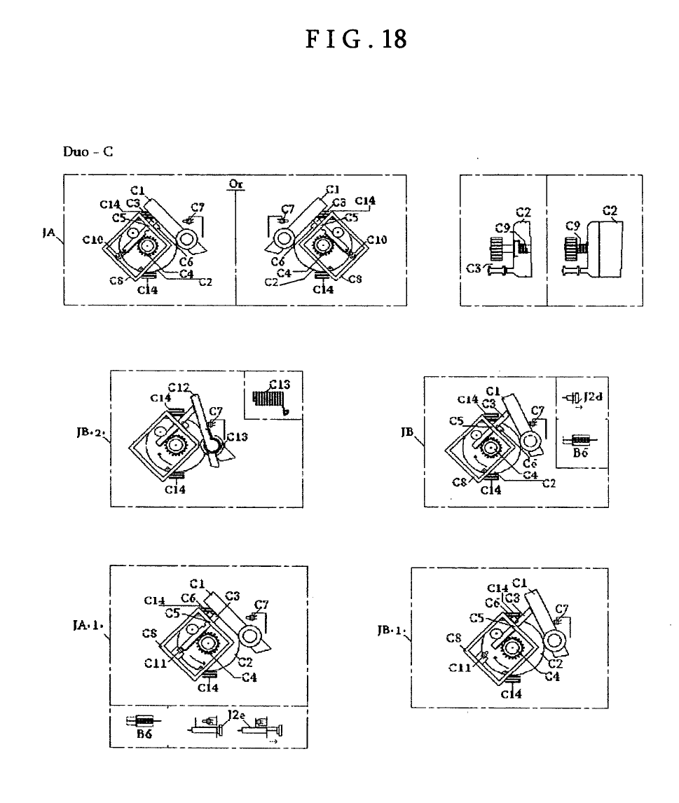

FIG. 18; Axis-gear structure Duo-C: JA We install motor between supporting springs C14, it is fixed a frame C8 with a short tube outlet C5 where an axis engages in it, this axis C3 has its groove end part connected with a gear C4 of motor C2, spin is its braking action against pedal part C1 at JB. Switch C7 turns motor off prior to locking at device C6 or equivalent during braking, return spin can be used by either outer/inner rewind spring C9; spring C10 linking at axis end to the frame or rewind spring C13 of automatic brake pedal C12 at JB(2), releasing is by driver's button J2d. If we use double revolving motor, releasing is by driver's contact J2e and JA(1) switch C11 is to turn motor off at back spin. Function includes sensors or radars.

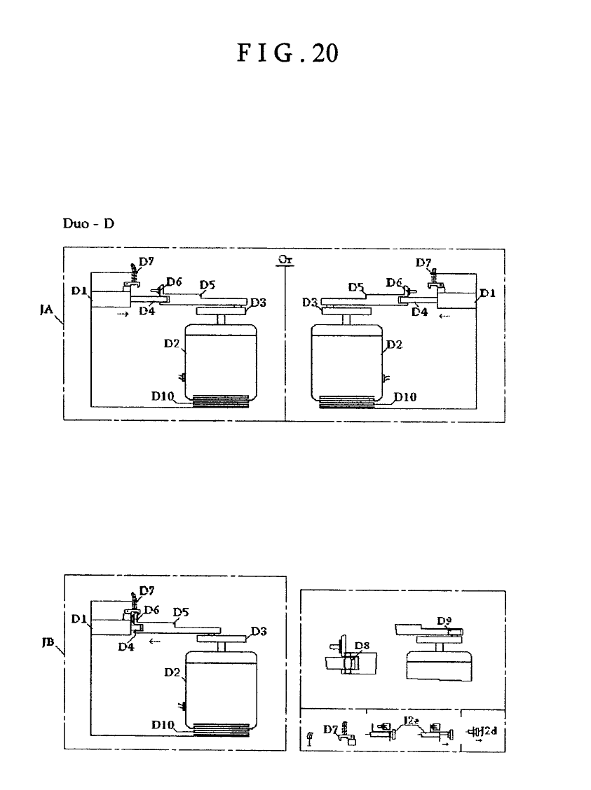

FIG. 20; Extra outlet structure Duo-D: JA Another suggestion is to build an additional outlet device from original booster/master cylinder besides the brake-by-pedal one, this outlet D1 possesses spring force to push its rod out before braking. Rod D4 functions a connecting rod kit D5 with roller D8 & ball bearings D9, it is fixed at the border between center and rim of a round wheel D3, this wheel engages a right & left spinning motor D2 with support spring D10. Radar(s) or sensor(s) directs braking JB then motor will be turned off by switch D6 prior to locking at device D7, releasing is by driver's button J2e at back spin. If a strong spring is equipped at extra outlet for back spin, a simple motor can be utilized with button J2d releasing.

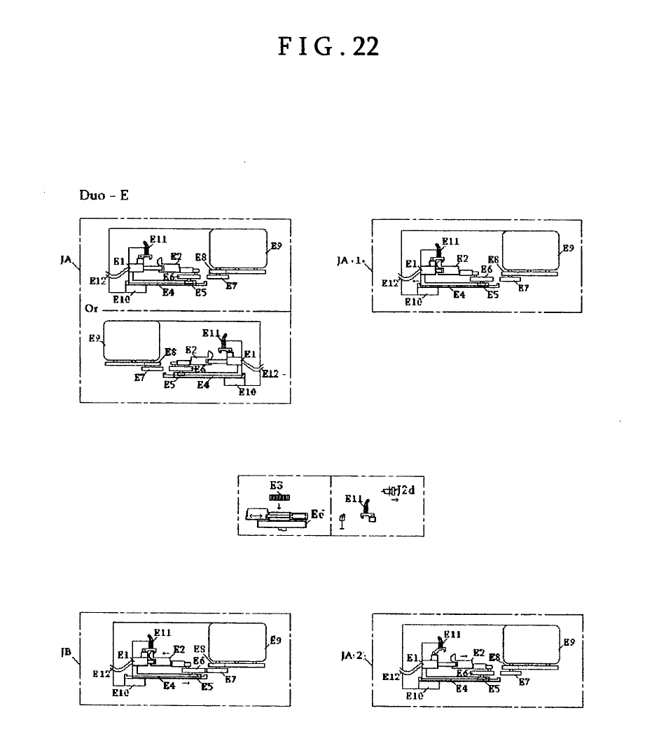

FIG. 22; Moving frame structure Duo-E: JA Extra outlet E1 & complete connecting rod bearing kit with spring E3 in an air releasing unit E2 can place on a moving frame E4 with a rotating wheel centered to a ball bearing E5. This wheel E6 will automatically connect JB (to brake) and disconnect JA(1) (to release) to a rubber cover wheel E7 manufactured as a part of double pulley E8 being rotated by car engine E9 to replace a motor. Sensor(s) or radar(s) commands oscillator E10 (with spring) to move the frame braking as well as releasing, braking is locked by lock device E11 which will be unlocked JA(2) by driver's contact J2d. Certain part of fluid pipe needs changing to hose E12 for moving adaptation.

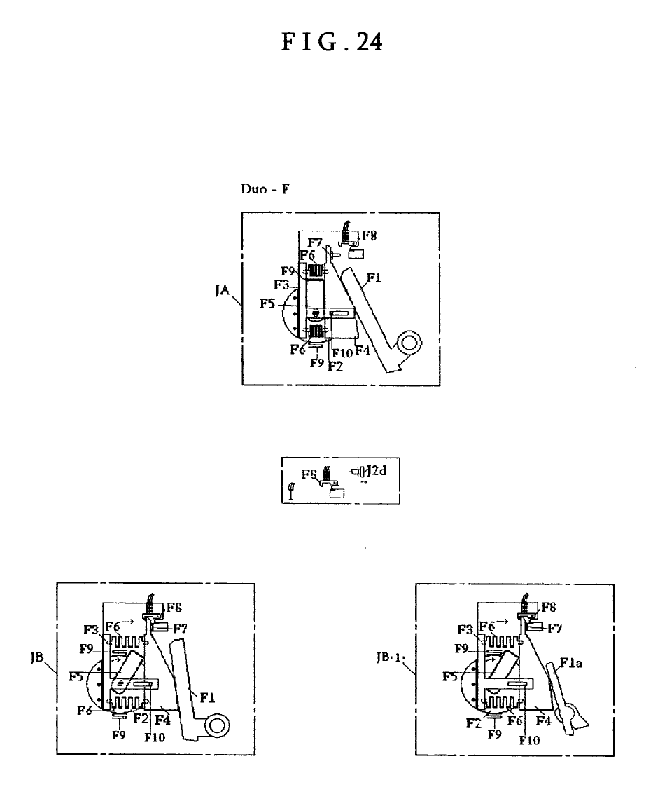

FIG. 24; Bracket drive structure Duo-F: JA We simply lock two springs F6 from a frame F3 to both ends of the frame covered bar F4 which holds a pin F10 moving in its frame cavity, a rectangular bracket F5 is fixed therein to drive it, its outer part is against pedal part F1 or automatic brake pedal Fla. Motor F2 with support springs F9 drives its bracket to brake and spring force releases. A switch F7 places at the end of bar to turn motor off before the bar is locked by lock device F8 during braking at JB or JB(1) under function of radar(s) or sensor(s), driver's button J2d is for releasing.

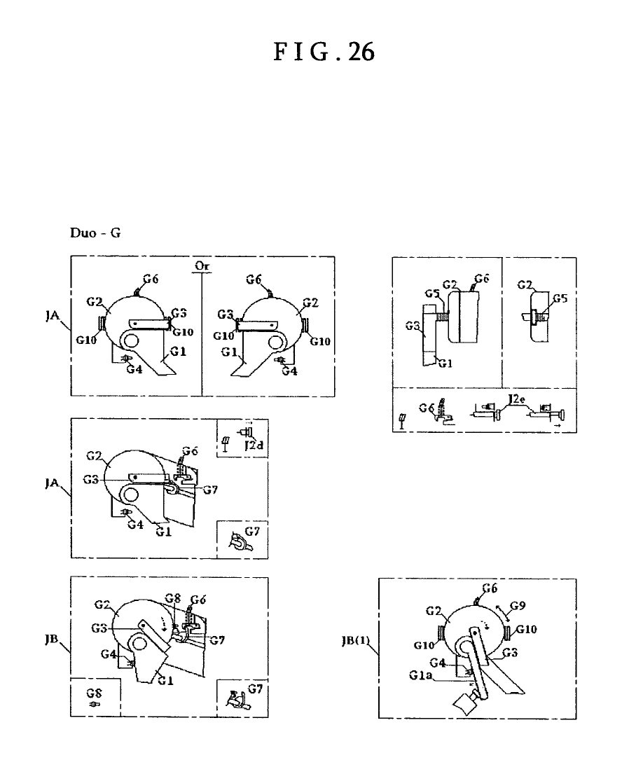

FIG. 26; Direct spin structure Duo-G: JA Spring supporting G10 motor G2 is equipped next to pedal part G1 or automatic brake pedal G1a with its bar G3 to brake, outer or inner rewind spring G5 releases. Device G6 locks its inner wheel G7 when radar(s) or sensor(s) operates to brake JB or JB(1) in which motor has adjustable position G9, it will be turned off by switch G4 prior to locking, driver's button J2d is drawn to release. If we use a double rotating motor at back spin, we release at contact J2e to switch G8 off.

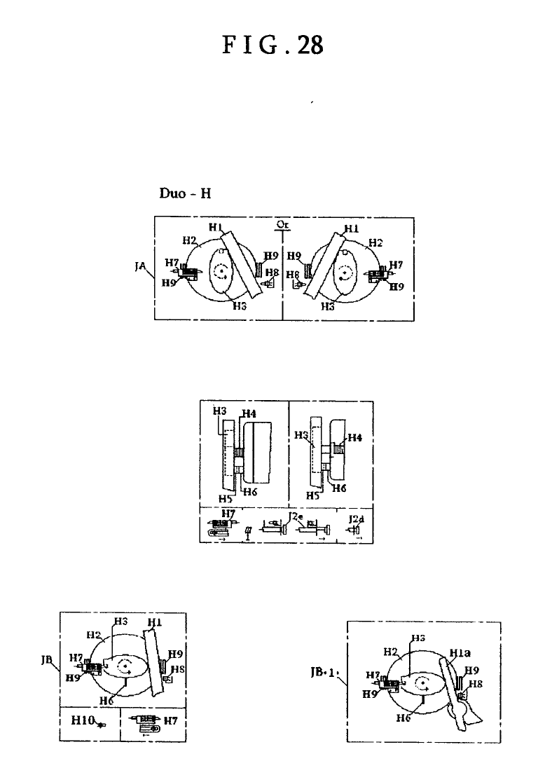

FIG. 28; Oval wheel structure Duo-H: JA Radars/sensors are to detect, oval wheel H3 of support spring H9 motor H2 brakes at pedal part H1 or automatic brake pedal H1a, outer or inner rewind spring H4 is for back spin, the wheel has a bracket arm H5 to blockade itself at motor iron bar H6. Lock device H7 locks its wheel after motor is turned off by switch H8 during braking at JB or JB(1), driver's button J2d is drawn to release. If we use double spinning motor, contact J2e is for releasing and a switch off H10 is added to motor bar for back spin.

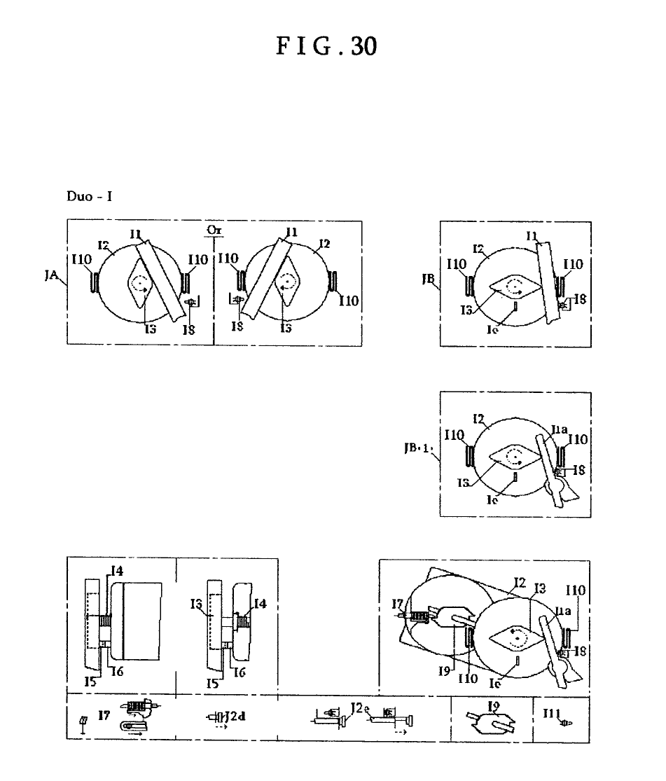

FIG. 30; Hexagonal wheel structure Duo-I: JA Hexagonal wheel 13 or equivalent equipped supporting springs 110 with motor 12 is to brake on pedal part 11 or automatic brake pedal 11a, back spin is by outer or inner rewind spring 14, wheel has a bracket arm 15 to blockade itself at motor iron bar 16. Radar(s) or sensor(s) functions, inner wheel 19 locks at device 17 while braking JB or JB(1) after turning off by switch 18, releasing is by driver's button J2d. If we use double spinning motor, contact J2e is for releasing and a switch off 111 is added to motor bar for back spin.

FIG. 31 shows entire braking system network and electrical circuit of the control unit J5. FIG. 32 is a diagram of electrical connection of driver contacts J2 to red or yellow signal lamp J3 and braking system standby J4b1 & braking system movement J4 b2.

An appropriate motor will brake its car fast enough to stop its running. If a double rotating motor is used, it should have low speed at back spin. FIG. 32; Button J2c is utilized to switch motor on rotating to release braking unit “C”, button J2d is drawn releasing braking unit “d” and button J2e is for releasing braking unit “e”.

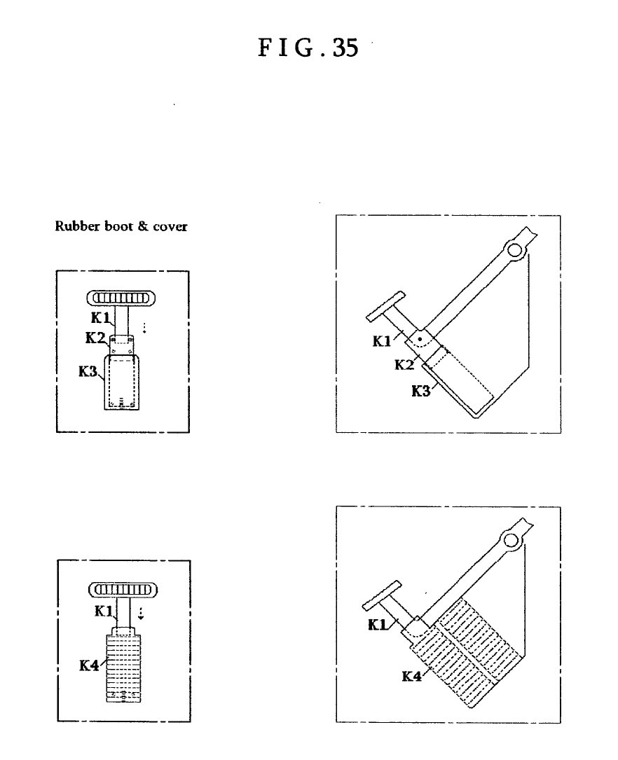

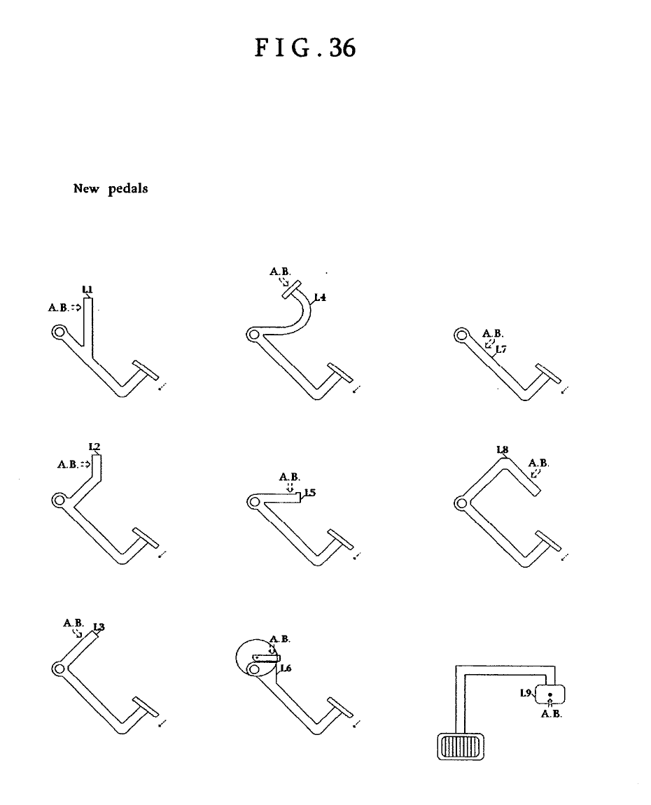

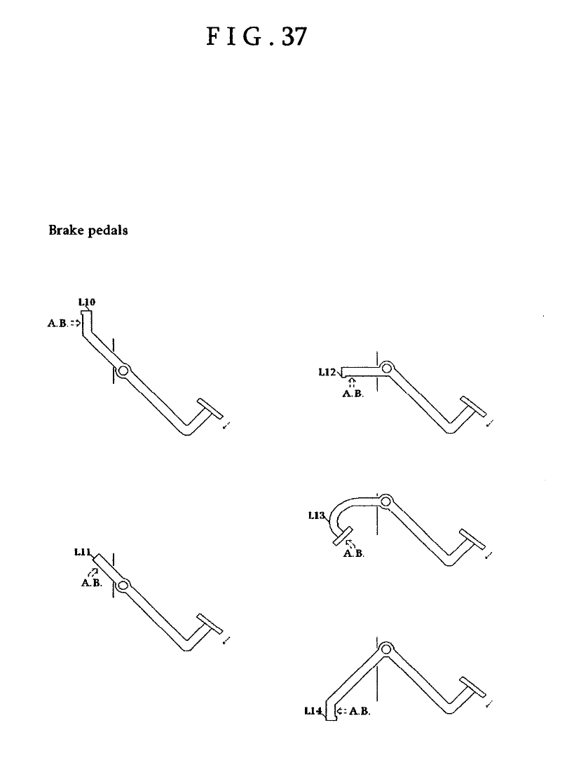

Automatic braking unit brakes at the opposite side of pedal, however it depends on structures of vehicle, braking motor A.B. may be equipped at any position to brake against new pedal from L1 to L9 FIG. 36 and L10 to L14 on FIG. 37 provided it is covered safely. FIG. 35: It is to be fixed rubber boot K4 or covers K2 and K3 under pedal K1 for safe protection during automatic braking movement.

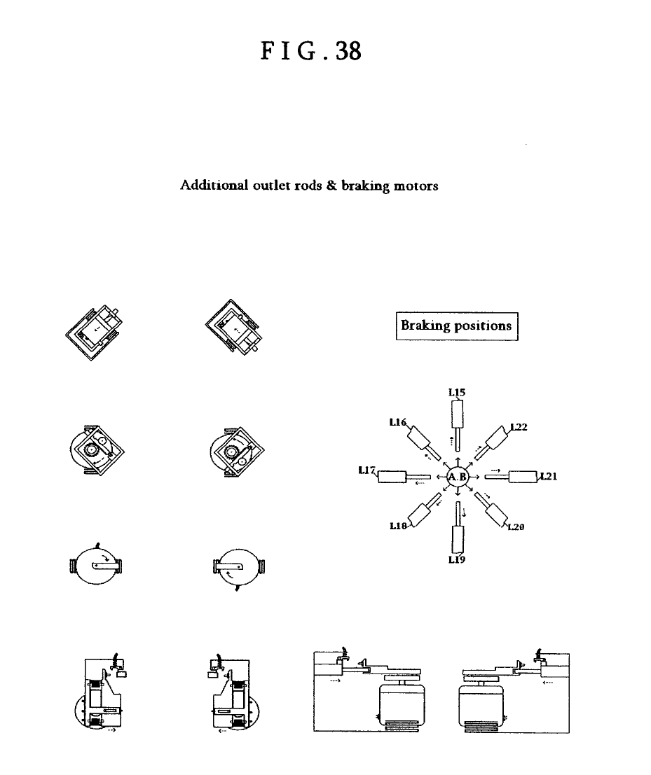

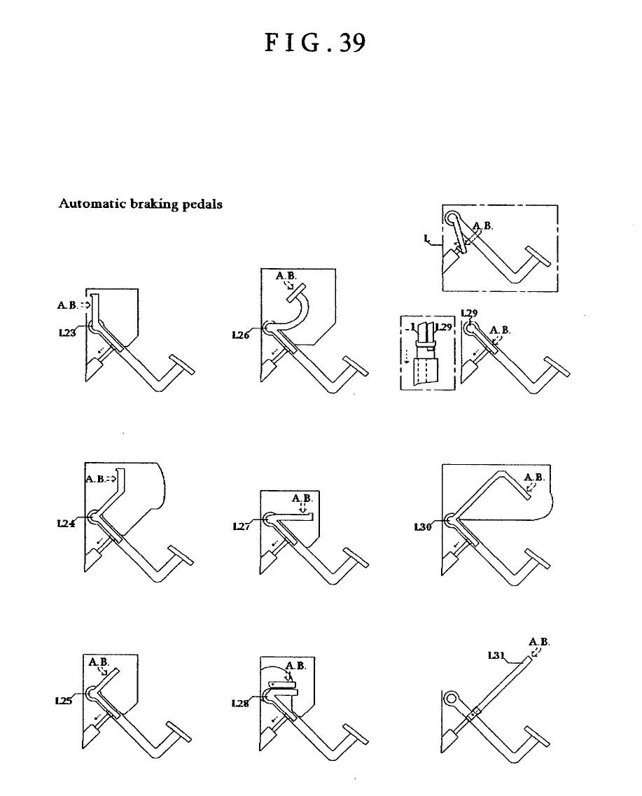

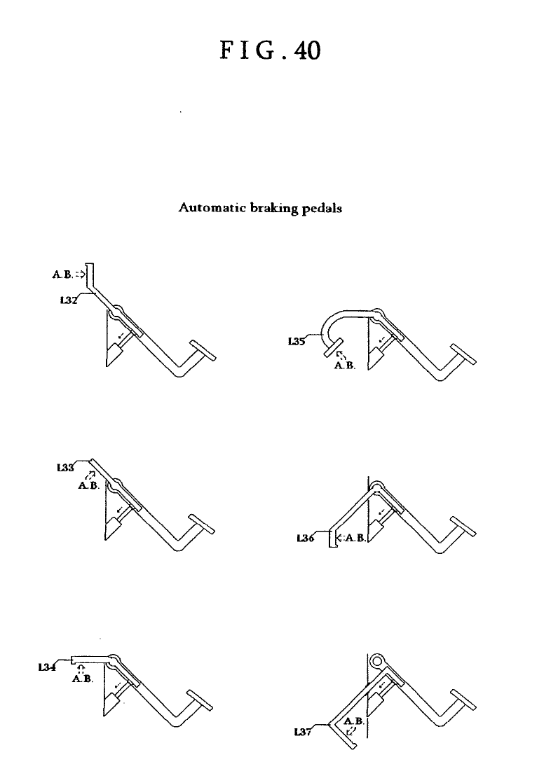

Certain types of braking motor A.B. can well be placed to brake against additional outlet braking rod besides original booster/master cylinder one in a choice of up to eight positions: L15 to L22 FIG. 38. Furthermore, FIG. 39 and FIG. 40 provide 15 types of automatic braking pedal from L23 to L37 for proper automatic braking use without causing the movement of vehicle pedal L shown at FIG. 39. The entire braking structures can be modified by pulling to brake instead of pushing actions to the same effect.

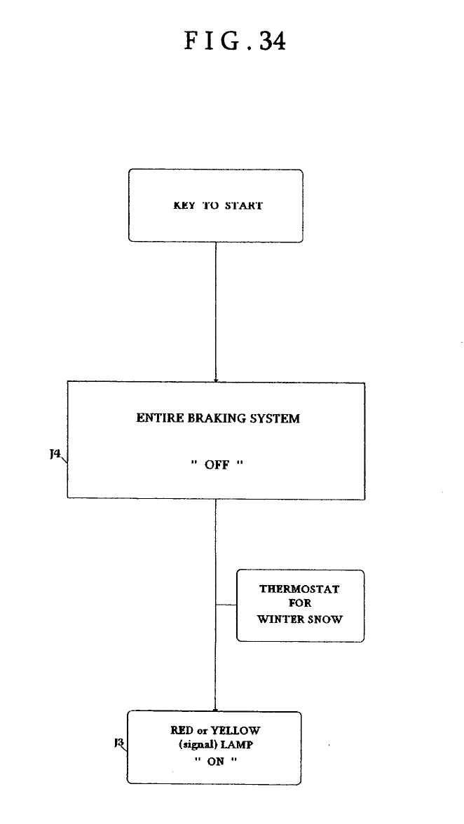

FIG. 34; Red or yellow signal lamp J3 is “on” showing to driver while entire system J4 is “off”. FIG. 32; Driver may switch off the entire system by driver's contact J2b to J2a when necessary or driver finds impossible to balance his car on ice-covered road in winter snow if braking operates, a thermostat should so be installed to disconnect yellow signal lamp.

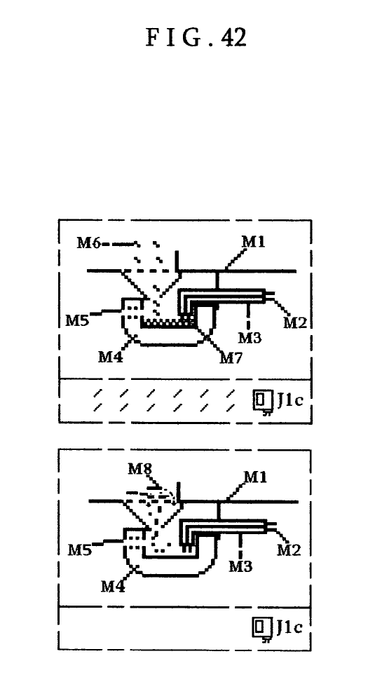

FIG. 42; Automatic water switch M1 is installed to be connected by raining water M7 when it rains M6 to turn radar J1c on, it has isolated M3 electrical wires M2, water will flow out at a level opening M5 from plastic container M4. The wind M8 will blow water off to extinguish the function of radar J1c after raining is over.

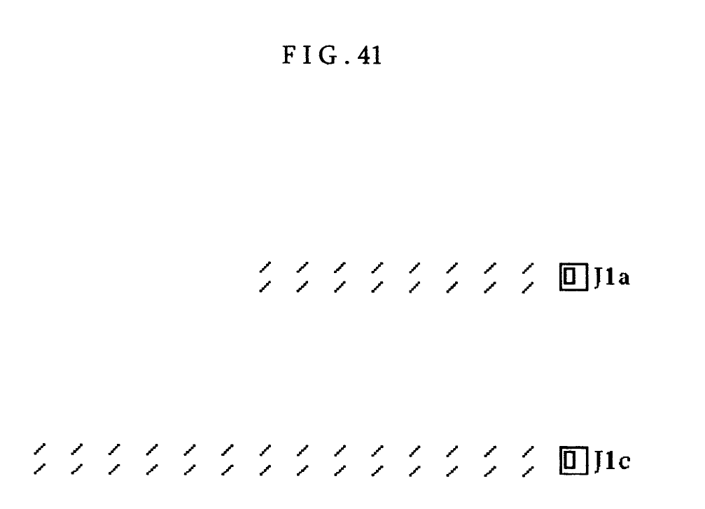

FIG. 41; Two radars/sensors are set separately or combined in one unit on the top of front car or somewhere in/at its front at a position level to prevent direct lighting beam flashing at night time from running cars at opposite side, J1a radar has capacity to detect at certain distance while J1c detects longer distance to react earlier to stop car running on wet and slippery road when it rains. Technically, an extra front radar should be equipped detecting at the earliest among these radars to sound sonorous signal lamp or recorded message to driver once obstruction is detected by this radar, driver may lower car speed before automatic braking operates.

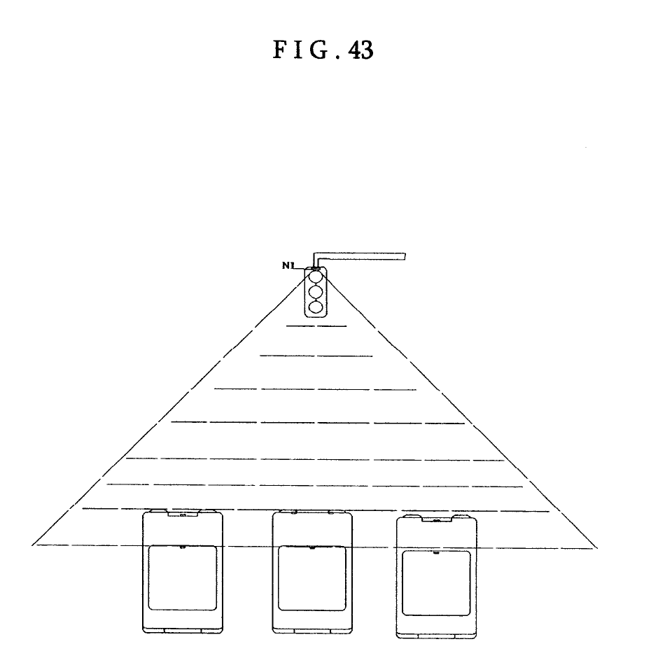

FIG. 43; Normal traffic green red light should likewise be modernized to be an absolute security device in traffic control system. Automatic stop control lamp N1 is a particular flash/color lighting lamp or equivalent added onto traffic sign (green red light) at a position to focus its beam on car front radars reacting the function of automatic braking unit to stop cars advancing on red in the lighting zone limit.

1-3. (canceled)

4. What I claim as my invention is: Automatic braking device stopping traffic accident for all motor/engine vehicles, automobiles, cars, trucks, buses, vans, trains, tanks, motorcycles, airplanes, ships, submarine comprising either sensor(s) or radar(s) being equipped therein for detecting at specified distance between vehicle and obstruction, for reacting against obstruction based on the result of detection detected by sensor(s) that automatic braking being operated for stopping motor/engine vehicle running, including:
either sensors or other equivalents having capacity for detecting both vehicle and human body, with anti-snow, against light of opposite vehicle flashing facilities being equipped in front and rear motor/engine vehicle for detecting at specified distance both connecting to automatic braking (motor) unit, rear radar being connected through switch of rear lamp to be switched on during backing,
second front sensor being equipped in motor/engine vehicle for detecting at longer specified distance against obstruction for functioning automatic braking earlier on wet road driving, raining water connecting between electric wire of sensor to that of automatic braking (motor) unit, indicator lamp shown, extinguishing connection by wind drying water to its box after raining over of automatic water switch,
third front sensor being equipped in motor/engine vehicle for detecting at the longest specified distance against obstruction, connecting either (indicator) sonorous signal lamp or message recorder to sound driver for lowering vehicle speed averting automatic braking,
speedometer being used as a switch for connecting between third sensor and either (indicator) sonorous signal lamp or message recorder at high speed, speed below 15 without sensor connection for motor/engine vehicle approaching closer during heavy traffic, speedometer pointer conducting to indicator (rear) surface at any speed as desirable for connecting sensor(s) in operation, a revert timer be equipped instead for switching third sensor off, of automatic lowering speed,
extra sensors being installed at right and left mirrors of motor/engine vehicle connecting signal lamp to switch it on for back detecting during turning, connecting either sonorous signal lamp on indicator or voice recorder for sounding driver in case rear vehicle being detected at a specified distance,
small sensors being installed at both sides of motor/engine vehicle for detecting extremely approaching running vehicles, connecting- to (indicator) color signal lamps shown on indicator that right or left side under detection,
either signal lamp switch or a switch at steering wheel being connected for switching automatic braking device off for averting its function in motor/engine vehicle against opposite vehicle during turning,
a driver's contact being connected in motor/engine vehicle for turning automatic braking device off during which for turning either (indicator) sonorous color signal lamp or voice recorder on sounding to driver and a thermostat being equipped against cold temperature of snow for turning (indicator) color signal lamp off of automatic safety connection,
automatic releasing process; sensor being connected to automatic braking unit and mini-motor for reacting against obstacle both functioning of braking operation and pressing button device standby of mini-motor therein for rotating to draw lock device resulting from earlier pressing action for releasing the brake automatically just after sensor detecting free, if desirable, either automatic braking device or a second braking unit without lock being connected therein for lowering speed at a desirable specified distance of sensor detection and speedometer speed,
automatic braking unit; Triangle wheel structure, Duo: sensor(s) being connected for detecting obstacle, triangle wheel of motor with supporting springs rotating to its edge point for operating braking on part of upper pedal, iron switches being connected for turning motor off, for locking its inner triangle wheel during braking, installing spring to pull and switch device on rotating motor for releasing brake, for Duo; lock device of motor for locking bracket arm of triangle wheel during braking after being turned off by equipping switch, driver's button and either rewind spring or double spinning motor on of triangle wheel structure Du being equipped for releasing brake at back spin,
automatic braking unit; Round wheel structure Duo-A, Duo-a: sensor(s) being connected for detecting obstacle, an axis fixing between center and rim of a round wheel of motor with supporting springs rotating at wheel summit for operating braking on pedal part, a switch being connected for turning motor off, braking locked by installing lock device of motor to either bracket arm of wheel or inner wheel, driver's button and either rewind spring or double spinning motor being equipped for releasing brake,
automatic braking unit; Screw & Unscrew structure Duo-B: sensor(s) being connected for detecting obstacle, a toothed spindle engaging through gear-nut of frame with motor under supporting springs screwing out for operating braking on pedal part, a switch being connected for turning motor off, lock device being installed for locking spindle during braking, driver's button and either slotted spindle spring or spring linked to frame being equipped for releasing brake,
automatic braking unit; Axis-gear structure Duo-C: sensor(s) being connected for detecting obstacle, an axis engaging a tube outlet of frame with grooved end part rotated by a gear of motor with supporting springs moving axis for applying brake on pedal part, a switch being connected for turning motor off, lock device for locking axis during braking, driver's button and spring being installed for releasing brake,
automatic braking unit; Extra outlet structure Duo-D: sensor(s) being connected for detecting obstacle, an axis fixing between center and rim of a round wheel with connecting rod of motor under supporting springs for applying brake to an extra outlet built from brake original booster master cylinder, a switch being connected for turning motor off, lock device for locking connecting rod during braking, driver's button and revert spring being installed for releasing brake at back spin,
automatic braking unit; Moving frame structure Duo-E: extra outlet with hose and complete connecting rod kit with spring in an air releasing unit installing ball bearing centered to a wheel being fixed on a moving frame, sensor(s) being connected for detecting obstacle, oscillator reacting wheel of frame pressing to a rubber cover wheel manufactured as a part of double pulley rotated by car engine for applying brake, lock device for locking air releasing unit during braking, driver's contact being installed for releasing brake,
automatic braking unit; Bracket drive structure Duo-F: sensor(s) being connected for detecting obstacle, two springs from a frame of motor with supporting springs fixed to both ends of a frame bar holding a pin moving in frame cavity, a rectangular bracket being installed therein to drive it against pedal part for operating braking, a switch being connected for turning motor off, lock device for locking bar during braking, driver's button and spring being equipped for releasing brake,
automatic braking unit; Direct spin structure Duo-G: sensor(s) being connected for detecting obstacle, motor with supporting springs equipped next to pedal part rotating its bar for operating braking on it, a switch being connected for turning motor off, lock device for locking inner motor wheel during braking, driver's button and rewind spring being equipped for releasing brake,
automatic braking unit; Oval & Hexagonal wheel structure Duo-H, Duo-I: sensor(s) being connected for detecting obstacle, motor with supporting springs rotating its wheel for applying brake on pedal part, a switch being connected for turning motor off, lock device for locking either wheel or inner motor wheel during braking, driver's button and rewind spring being equipped for releasing brake,
either brake pedal of upper part being prolonged for applying brake under different positions or automatic braking pedal; a same axis being installed for movement of both extra pedal and vehicle pedal for applying brake independently under different positions,
lock device; a spring pushing a bar through frame outlet in device, outer part of bar for locking bracket (of wheel) approaching over it to be blockaded therein by spring force, end part of bar being fixed with a cable through inner spring from device to either mini-motor or driver's contact by drawing for releasing brake.

5. What I claim as my invention is: Automatic traffic light device for stopping all motor/engine vehicles without surpassing on red, including lamp(s) being equipped either on traffic signal or in area nearby, its beam flashing at specified zone for reacting function of automatic braking devices of front vehicles approaching and stopping on red for averting further advancing.

6. What I claim as my invention is: Automatic braking device stopping traffic accident for all motor/engine vehicles, automobiles, trucks, buses, vans, trains, tanks, motorcycles, trains, airplanes, ships, submarine referring to claim 4 and Automatic traffic light device for stopping all motor/engine vehicles without surpassing on red referring to claim 5 wherein the original elements, composition, function, structures, process of making, installation, of the invention, any other structures, modifications, replacement of parts, of facilities being assembled for performing both the same devices and similar devices referring to their original fundamentals to the same effect and combining the invention with any other devices or systems under other names are in the scope of the protection of the invention, the invention be used everywhere.
